(19) United States
(12) Patent Application Publication
(10) Pub. No.: US 2005/0266903 A1
(43) Pub. Date: Dec. 1, 2005

(54) Information device and diversity antenna control method

(76) Inventor: Toshiyuki Masaki, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/088,906

(22) Filed: Mar. 25, 2005

(30) Foreign Application Priority Data
May 27, 2004 (JP) 2004-157805

(51) Int. Cl. H04B 1/06; H04B 7/00; H04M 1/00

(52) U.S. Cl. 455/575.7; 455/562.1

(57) ABSTRACT

A level comparison circuit compares the reception qualities of the reception signals received by first and second reception circuits, determines which is higher in reception quality, and notifies a diversity switching signal generating circuit of the corresponding information. An antenna switching control circuit performs switching control of antenna switches provided in an antenna unit and switches provided in an antenna unit in accordance with switching signals generated by using a diversity switching signal output from the diversity switching signal generating circuit.

### CROSS-REFERENCE TO RELATED APPLICATIONS

This application is based upon and claims the benefit of priority from prior Japanese Patent Application No. 2004-157805, filed May 27, 2004, the entire contents of which are incorporated herein by reference.

### BACKGROUND OF THE INVENTION

1. Field of the Invention

The present invention relates to an information device and diversity antenna control method which can be suitably applied to a personal computer having a radio communication function, an electronic device having a function of receiving radio information accompanying pictures, and the like.

2. Description of the Related Art

In radio communication, from the point of view of countermeasures against fading, a diversity scheme is often used for a receiving antenna.

As a diversity scheme, for example, the following schemes are known well: a spatial diversity scheme of arranging two antennas in consideration of the distance between them as disclosed in Jpn. Pat. Appln. KOKAI Publication No. 2000-114848; and a polarization diversity scheme of arranging two antennas in consideration of the angle defined by them.

Depending on a radio communication device serving as a communication partner, there may be an offset in the polarization components of a transmission radio wave. In this case, a spatial diversity arrangement is preferably formed by using antennas capable of receiving strong polarization components. If, for example, both the radio waves to be received by two antennas contain strong horizontal polarization components, a spatial diversity arrangement is formed by using the two antennas as horizontal polarization antennas. In some case, the right and left antennas may be made to operate as a horizontal polarization antenna and vertical polarization antenna, respectively.

As described above, in order to ensure a wide communication range, a diversity antenna arrangement must be flexibly changed in accordance with the antenna polarization characteristics of a radio communication device serving as a communication partner.

In the arrangement based on the technique disclosed in the above reference, however, either spatial diversity or polarization diversity must be selected. This arrangement therefore makes it impossible to realize a sufficiently wide communication range. Furthermore, this arrangement cannot flexibly and effectively cope with radio interference, multipath, and the like.

In an information processing device such as a portable computer, a radio communication module such as a wireless LAN or Bluetooth (registered trademark) module can be mounted. The wireless LAN module is equipped with a main antenna which performs transmission/reception and an auxiliary antenna which performs only reception in order to improve radio wave reception quality. Depending on a reception condition, control (spatial diversity control) is performed to switch the main and auxiliary antennas so as to maintain a reception state with better sensitivity. On the other hand, the Bluetooth (registered trademark) module uses only one antenna for transmission/reception. In addition, when the wireless LAN module complies with IEEE802.11b, its operating frequency band overlaps that of the Bluetooth (registered trademark) module. If, therefore, these modules are used at the same time, radio interference may occur, which decreases their communication speeds. In consideration of such problems, a total of three antennas, i.e., two antennas for the wireless LAN modules and one antenna for the Bluetooth (registered trademark) module, are separately provided to minimize radio interference. However, in compact electronic devices such as portable computers, owing to demands for a reduction in size and an increase in packing density, there is a trend toward less space being available for the antenna in the housings. In this case, the number of antennas to be mounted can be decreased by applying a technique of allowing a plurality of types of radio communication modules to share one or two antennas upon selective switching by a switch circuit. This technique, however, requires a control circuit which performs switching control of the switch circuit in accordance with the radio communication state or the like of each radio communication module. This complicates the arrangement. In addition, only the radio communication module connected to an antenna by the switch circuit can perform reception.

### BRIEF SUMMARY OF THE INVENTION

According to the present invention, there is provided an information device comprising a pair of antenna units each including two antennas having different polarization characteristics or different directivities and a switching circuit which switches and outputs a composite reception signal of signals received by the two antennas or a reception signal received by one of the two antennas, and antenna switching control means for performing switching control of the switching circuit of the pair of antenna units so as to form an antenna of a diversity scheme.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, server to explain the principles of the invention.

FIG. 1 is a block diagram showing an example of the arrangement of the main part of the diversity antenna mechanism of an information device having a radio communication function according to an embodiment of the present invention;

FIG. 2 is a view showing an example of an antenna arrangement in a case wherein the diversity antenna mechanism according to the above embodiment is mounted in a portable information device such as a portable computer;

FIG. 3A is a view showing an example of the arrangement of an antenna unit (the upper surface of an antenna board) used in the diversity antenna mechanism according to the above embodiment;

FIG. 3B is a view showing an example of the arrangement of an antenna unit (the lower surface of an antenna board) used in the diversity antenna mechanism according to the above embodiment;

FIG. 4A is a view showing an example of the radiation characteristics (vertical polarization gain characteristics) of each antenna element mounted on the antenna board according to the above embodiment;

FIG. 4B is a view showing an example of the radiation characteristics (horizontal polarization gain characteristics) of each antenna element mounted on the antenna board according to the above embodiment;

FIG. 5A is a view showing an example of the radiation characteristics (vertical polarization gain characteristics) of each antenna element mounted on the antenna board according to the above embodiment;

FIG. 5B is a view showing an example of the radiation characteristics (horizontal polarization gain characteristics) of each antenna element mounted on the antenna board according to the above embodiment;

FIG. 6A is a view showing an example of the composite output characteristics (vertical polarization gain characteristics) of a mixer mounted on the antenna board according to the above embodiment;

FIG. 6B is a view showing an example of the composite output characteristics (horizontal polarization gain characteristics) of a mixer mounted on the antenna board according to the above embodiment; and

FIG. 7 is a flowchart showing an example of an antenna switching control sequence for the diversity antenna mechanism according to the above embodiment.

### DETAILED DESCRIPTION OF THE INVENTION

An embodiment of the present invention will be described below with reference to the views of the accompanying drawing.

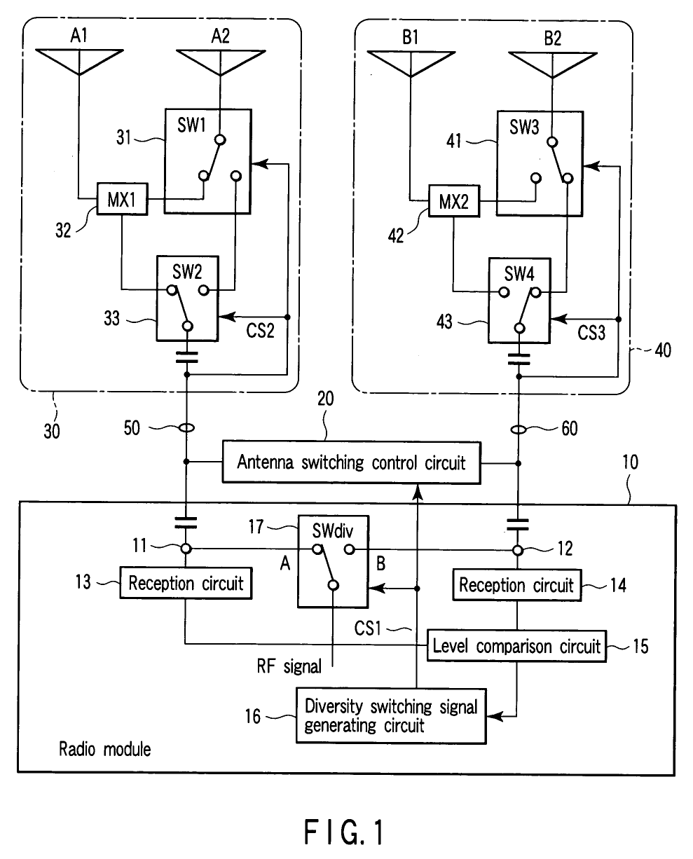

FIG. 1 shows an example of the arrangement of the main part of the diversity antenna mechanism of an information device having a radio communication function according to an embodiment of the present invention. The diversity antenna mechanism shown in FIG. 1 is comprised of a radio module 10 which has a function of outputting a diversity switching signal (CS1) and a pair of antenna units 30 and 40 each of which performs switching control of two antennas upon reception of a diversity switching signal from the radio module 10.

The radio module 10 includes first and second antenna input terminal 11 and 12, first and second reception circuits 13 and 14 which separately receive signals through the first and second antenna input terminals 11 and 12, a level comparison circuit 15 which compares the reception qualities of the first and second reception circuits 13 and 14, a diversity switching signal generating circuit 16, and a diversity switch 17. The radio module 10 can be applied to an existing diversity antenna system. In this embodiment, the level comparison circuit 15 compares at least reception levels or bit error rates as reception qualities.

The antenna unit 30 includes antennas A1 and A2 having different polarization characteristics or directivities, an antenna switch (SW1) 31, a mixer (MX1) 32, and an antenna switch (SW2) 33. The antenna switch (SW1) 31 and antenna switch (SW2) 33 are operated so as to be interlocked with each other.

The antenna unit 40 includes antennas B1 and B2 having different polarization characteristics or directivities, an antenna switch (SW3) 41, a mixer (MX2) 42, and an antenna switch (SW4) 43. The antenna switch (SW3) 41 and antenna switch (SW4) 43 are operated so as to be interlocked with each other.

The antenna unit 30 is RF-connected to the first antenna input terminal 11 of the radio module 10 through a signal cable 50. The antenna unit 40 is RF-connected to the second antenna input terminal 12 of the radio module 10 through a signal cable 60.

The antenna switches (SW1 and SW2) 31 and 33 provided in the antenna unit 30 and the antenna switches (SW3 and SW4) 41 and 43 provided in the antenna unit 40 are switched/controlled by switching signals (CS1 and CS2) output from an antenna switching control circuit 20.

The antenna switching control circuit 20 performs switching control of the antenna switches (SW1 and SW2) 31 and 33 provided in the antenna unit 30 and the antenna switches (SW3 and SW4) 41 and 43 provided in the antenna unit 40 by using the switching signals (CS2 and CS3) formed by using the diversity switching signal (CS1) output from the diversity switching signal generating circuit 16 provided in the radio module 10.

With the above arrangement, the first antenna input terminal 11 of the radio module 10 receives the composite reception signal obtained by mixing the reception signals received by the antennas A1 and A2 provided in the antenna unit 30 using the mixer (MX1) 32 or the signal received by the antenna A2 upon switching control of the antenna switches (SW1 and SW2) 31 and 33. The second antenna input terminal 12 of the radio module 10 receives the composite reception signal obtained by mixing the reception signals received by the antennas B1 and B2 provided in the antenna unit 40 using the mixer (MX2) 42 or the signal received by the antenna B2 upon switching control of the antenna switches (SW3 and SW4) 41 and 43.

The reception signal input to the first antenna input terminal 11 of the radio module 10 and the reception signal input to the second antenna input terminal 12 are respectively input to the first and second reception circuits 13 and 14 to perform diversity switching control. The input signals are detected (demodulated) and supplied to the level comparison circuit 15.

The level comparison circuit 15 compares the reception qualities of the respective reception signals received from the first and second reception circuits 13 and 14. In this case, for example, under the condition that the reception signals are equal to or lower than a set error bit rate and equal to or higher than a set reception level, the level comparison circuit 15 compares the reception qualities of the respective reception signals received from the first and second reception circuits 13 and 14, and determines which is higher in reception quality. The determination signal is supplied to the diversity switching signal generating circuit 16.

The diversity switching signal generating circuit 16 generates a diversity switching signal (CS1) on the basis of the determination signal received from the level comparison circuit 15, and performs switching control of the diversity switch 17 by using the diversity switching signal (CS1).

The diversity switch 17 selects the reception signal input to the first antenna input terminal 11 or second antenna input terminal 12 in accordance with the diversity switching signal (CS1), and supplies the selected reception signal as a radio frequency reception signal (RF signal) to, for example, a radio communication circuit which performs radio communication in a predetermined frequency band.

The diversity switching signal (CS1) generated by the diversity switching signal generating circuit 16 is also supplied to an antenna switching control circuit 20.

The antenna switching control circuit 20 generates switching signals (CS2 and CS3) on the basis of the diversity switching signal (CS1) generated by the diversity switch 17, and performs switching control of the antenna switches (SW1 and SW2) 31 and 33 provided in the antenna unit 30 and the antenna switches (SW3 and SW4) 41 and 43 provided in the antenna unit 40 by using the switching signals (CS2 and CS3).

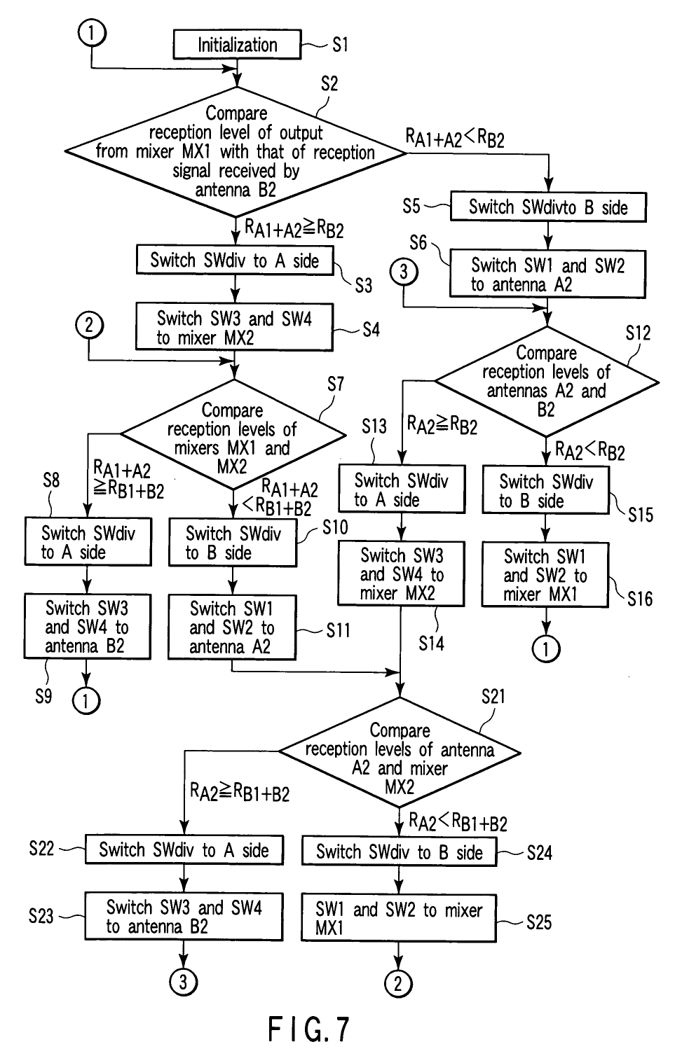

With this antenna switching control, an antenna arrangement with high reception quality is maintained, and an antenna arrangement with low reception quality is switched. This antenna arrangement switching is realized by interlocked switching of the antenna switches (SW1 and SW2) 31 and 33 or interlocked switching of the antenna switches (SW3 and SW4) 41 and 43. Diversity antenna switching operation by switching control in this case will be described later with reference to the flowchart shown in FIG. 7.

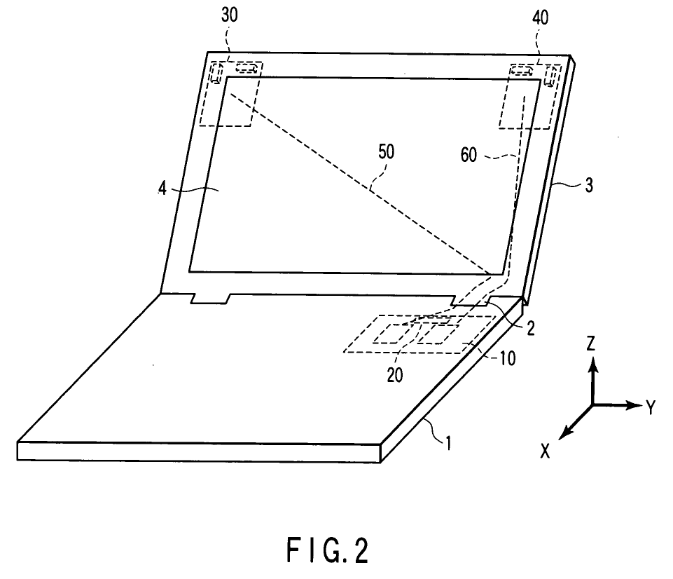

FIG. 2 shows an example of how the diversity antenna mechanism shown in FIG. 1 is mounted in a portable information device such as a portable computer.

A portable computer as an information device is comprised of a computer body 1 and a display unit housing 3 pivotally mounted on the computer body 1 through hinge portions 2. A computer board on which a CPU, memory, and the like are mounted is mounted in the computer body 1, together with the radio module 10 and antenna switching control circuit 20 shown in FIG. 1. A display device 4 such as an LCD is mounted in the display unit housing 3. In addition, the antenna units 30 and 40 are mounted in the display unit housing 3 on the free end side opposite to the hinge portions 2 so as to be laterally spaced apart from each other. The antenna units 30 and 40 are respectively circuit-connected to the first and second antenna input terminals 11 and 12 of the radio module 10 mounted in the computer body 1 through the signal cables 50 and 60. With this arrangement of the antenna units 30 and 40, when the display unit housing 3 is opened from the computer body 1 at the time of use of the computer, the respective antennas (A1, A2, B1, and B2) of the antenna units 30 and 40 are located at positions where good radiation characteristics can be obtained.

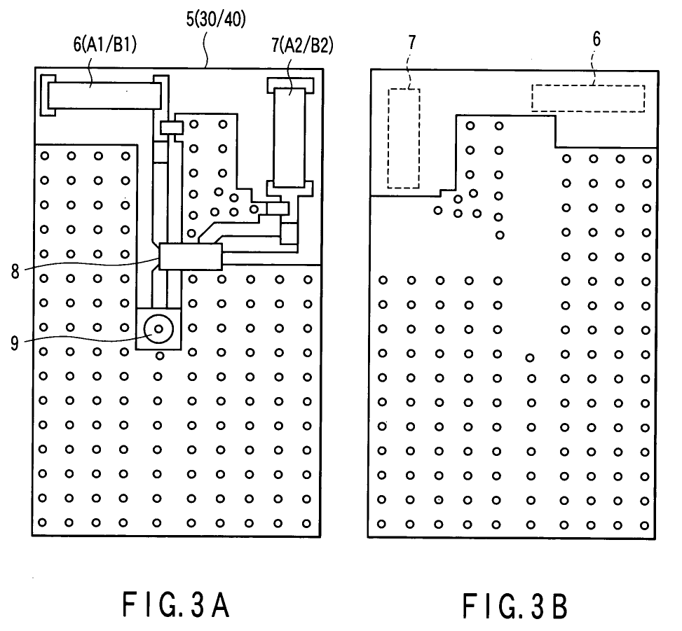

FIGS. 3A and 3B show an example of the arrangement of each of the antenna units 30 and 40 used for the diversity antenna mechanism having the arrangement shown in FIG. 1. In this case, each of the antenna units 30 and 40 is formed by using a single board (antenna board) 5. FIG. 3A shows the arrangement of the upper surface of the antenna board 5. FIG. 3B shows the arrangement of the lower surface of the antenna board 5.

On the antenna board 5 which forms the antenna unit 30 (40), an antenna element 6 which forms the antenna A1 (B1) and an antenna element 7 which forms the antenna A2 (B2) are arranged in consideration of polarization characteristics or directivities so as not to interfere with each other. For example, these elements are mounted in directions which differ from each other by 90°. As the antenna elements 6 and 7, any antenna elements can be used, e.g., ceramic chip antennas or inverted-F antennas. As the antenna board 5 which forms the antenna unit 30 (40), any board can be used, e.g., a glass epoxy board, ceramic board, or FPC board. The antenna element 6 which forms the antenna A1 (B1) and the antenna element 7 which forms the antenna A2 (B2) are circuit-connected to a chip 8 which forms the mixer 32 (42), and its output terminal (composite output terminal) is connected to a connector 9 which connects the signal cable 50 (60).

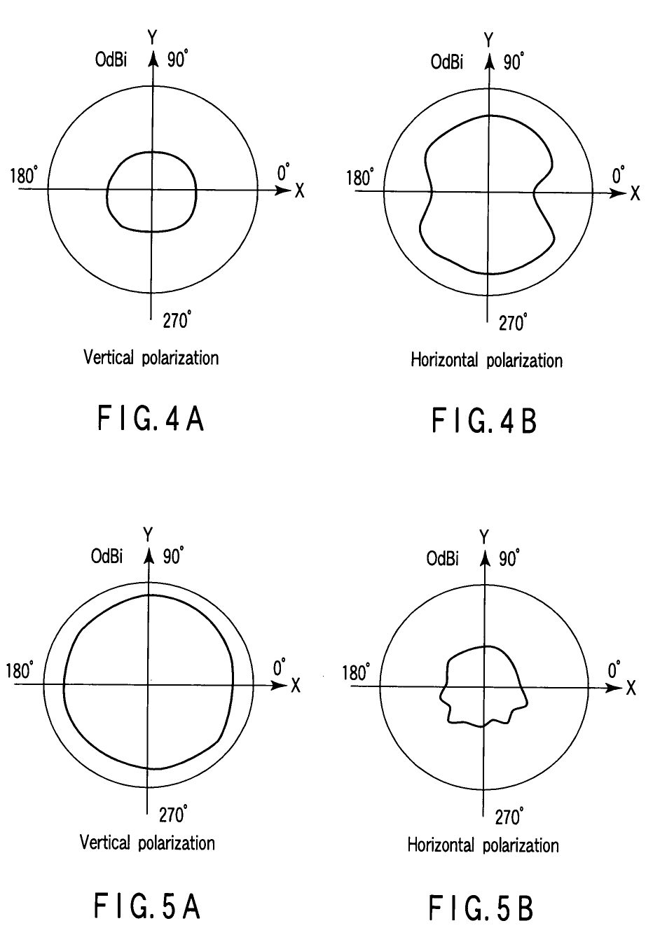

FIGS. 4A, 4B, 5A, and 5B show examples of the radiation characteristics (gain characteristics) of the antenna elements 6 and 7 mounted on the antenna board 5. As is obvious from the comparison between the vertical polarization characteristics shown in FIG. 4A and the horizontal polarization characteristics shown in FIG. 4B, the antenna element 6 has characteristics exhibiting a high gain with respect to horizontal polarization components within the X-Y plane, as shown in FIG. 4B. In contrast to this, as is obvious from the comparison between the vertical polarization characteristics shown in FIG. 5A and the horizontal polarization characteristics shown in FIG. 5B, the antenna element 7 has characteristics exhibiting a high gain with respect to vertical polarization components within the X-Y plane, as shown FIG. 5A.

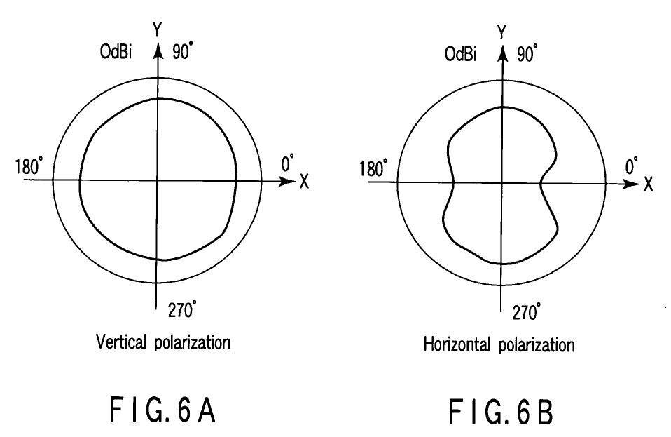

FIGS. 6A and 6B respectively show examples of the vertical polarization characteristics and horizontal polarization characteristics as composite output characteristics (gain characteristics) of the mixer 32 (42) formed by the chip 8 mounted on the antenna board 5. When the gains of the antenna A1 (B1) and antenna A2 (B2) are combined, gain characteristics lower in loss than those of each mixer by about 3 dB are obtained, thereby obtaining characteristics which allow reception of both horizontally and vertically polarized radio waves.

FIG. 7 shows an antenna switching control sequence for the diversity antenna mechanism having the arrangement shown in FIG. 1.

The antenna switching operation of the diversity antenna mechanism having the arrangement shown in FIG. 1 will be described with reference to FIG. 7. Assume that when the level comparison circuit 15 is to perform comparison, any reception signal which is equal to or lower than a predetermined error bit rate is treated as an effective signal to be compared. That is, when a reception signal exceeds the predetermined error bit rate, the reception level is set to level 0, and comparison is performed. In this case, let R_{A1+A2} be the level of the composite reception signal output from the mixer (MX1) 32, and R_{B2} be the reception level of the antenna B2.

In the processing shown in FIG. 7, initialization is performed first to set the antenna switches (SW1 and SW2) 31 and 33 in the switched states shown in FIG. 1. In this state, the antenna unit 30 supplies the signal received by the antenna A2 to the mixer (MX1) 32 through the antenna switch (SW1) 31, and supplies a composite output signal from the mixer (MX1) 32 to the first antenna input terminal 11 of the radio module 10 through the antenna switch (SW2) 33 and signal cable 50. On the other hand, the antenna unit 40 supplies the reception signal received by the antenna B2 to the second antenna input terminal 12 of the radio module 10 through the antenna switch (SW3) 41 and antenna switch (SW4) 43 (step S1).

With this operation, the composite reception signal obtained by mixing the reception signal supplied from the antenna A1 and the reception signal supplied from the antenna A2 through the antenna switch (SW1) 31 using the mixer (MX1) 32 is input to the first antenna input terminal 11 of the radio module 10. The reception signal received by the antenna B2 is input to the second antenna input terminal 12 of the radio module 10.

In the radio module 10, the composite reception signal of the signals received by the antennas Al and A2 which is input to the first antenna input terminal 11 and the reception signal received by the antenna B2 which is input to the second antenna input terminal 12 are detected (demodulated) by the first and second reception circuits 13 and 14, respectively, and are supplied to the level comparison circuit 15, which compares the reception qualities of the reception signals. In this case, as described above, when reception signals exceed the predetermined error bit rate, each reception level is regarded as level 0, and the level comparison circuit 15 compares the levels with each other to determine a signal with a higher level as a signal with high reception quality (step S2).

When the level comparison circuit 15 compares the levels of the reception signals (step S2) and determines that the signal level of the composite reception signal of the signals received by the antennas A1 and A2 which is input to the first antenna input terminal 11 is higher than (or equal to) that of the reception signal received by the antenna B2 which is input to the second antenna input terminal 12 (R_{A1+A2}≧R_{B2}), the diversity switch 17 selects the composite reception signal of the signals received by the antennas A1 and A2, which is input to the first antenna input terminal 11, by using the diversity switching signal (CS1) output from the diversity switching signal generating circuit 16 in accordance with the determination (step S3).

In accordance with the diversity switching signal (CS1), the antenna switching control circuit 20 performs switching control of the switches (SW3 and SW4) 41 and 43 provided in the antenna unit 40 by using the switching signal (CS3) to supply the reception signal received by the antenna B2 to the mixer (MX2) 42 through the switch (SW3) 41 and supply the composite output signal from the mixer (MX2) 42 to the second antenna input terminal 12 of the radio module 10 through the antenna switch (SW4) 43 and signal cable 50 (step S4).

In this state, the level comparison circuit 15 compares the signal level of the composite reception signal of the signals received by the antennas A1 and A2 which is input to the first antenna input terminal 11 with that of the composite reception signal of the signals received by the antennas B1 and B2 which is input to the second antenna input terminal 12, and determines which is higher in signal level (step S7).

If it is determined in this level comparison that the signal level of the composite reception signal of the signals received by the antennas A1 and A2 which is input to the first antenna input terminal 11 is higher than (or equal to) that of the composite reception signal of the signals received by the antennas B1 and B2 which is input to the second antenna input terminal 12 (R_{A1+A2}≧−R_{B1+B2}), the diversity switch 17 selects the composite reception signal of the signals received by the antennas A1 and A2, which is input to the first antenna input terminal 11, in accordance with the diversity switching signal (CS1) from the diversity switching signal generating circuit 16. That is, in this case, the composite reception signal of the signals received by the antennas A1 and A2 is continuously selected (step S8).

The antenna switching control circuit 20 performs switching control of the switches (SW3 and SW4) 41 and 43 provided in the antenna unit 40 by using the switching signal (CS3) on the basis of the diversity switching signal (CS1), thereby supplying the reception signal received by the antenna B2 to the second antenna input terminal 12 of the radio module 10 through the switch (SW3) 41 and antenna switch (SW4) 43 (step S9).

The level comparison circuit 15 compares again the signal level of the composite reception signal of the signals received by the antennas A1 and A2 which is input to the first antenna input terminal 11 with that of the reception signal received by the antenna B2 which is input to the second antenna input terminal 12 (step S2).

As described above, if the signal level of the composite reception signal of the signals received by the antennas A1 and A2 is higher than (or equal to) that of the composite reception signal of the signals received by the antennas B1 and B2 which is input to the second antenna input terminal 12 and that of the reception signal received by the antenna B2, the composite reception signal of the signals received by the antennas A1 and A2 is continuously selected (steps S2 to S4, S7 to S9, S2 . . . ).

Assume that when the signal level of the composite reception signal of the signals received by the antennas A1 and A2 which is input to the first antenna input terminal 11 is compared with that of the reception signal received by the antenna B2 which is input to the second antenna input terminal 12 (step S2), it is determined that the signal level of the composite reception signal of the signals received by the antennas A1 and A2 is lower than that of the reception signal received by the antenna B2 which is input to the second antenna input terminal 12 (R_{A1+A2} <R_{B2}). In this case, in accordance with this determination, the diversity switch 17 selects the reception signal received by the antenna B2, which is input to the second antenna input terminal 12, in accordance with the diversity switching signal (CS1) output from the diversity switching signal generating circuit 16 (step S5).

In addition, the antenna switching control circuit 20 performs switching control of the antenna switches (SW1 and SW2) 31 and 33 provided in the antenna unit 30 by using the switching signal (CS2) on the basis of the diversity switching signal (CS1), thereby supplying the reception signal received by the antenna A2 to the first antenna input terminal 11 of the radio module 10 through the antenna switch (SW1) 31 and antenna switch (SW2) 33 (step S6).

In this state, the level comparison circuit 15 compares the signal level of the reception signal received by the antenna A2 which is input to the first antenna input terminal 11 with that of the reception signal received by the antenna B2 which is input to the second antenna input terminal 12, and determines which is higher in signal level (aperture stop S12).

If it is determined in this level comparison that the signal level of the reception signal received by the antenna B2 which is input to the second antenna input terminal 12 is higher than that of the reception signal received by the antenna A2 which is input to the first antenna input terminal 11 (R_{A2}<R_{B2}), the diversity switch 17 selects the reception signal received by the antenna B2, which is input to the second antenna input terminal 12, in accordance with the diversity switching signal (CS1) from the diversity switching signal generating circuit 16 (step S15).

The antenna switching control circuit 20 performs switching control of the antenna switches (SW1 and SW2) 31 and 33 provided in the antenna unit 30 by using the switching signal (CS2) on the basis of the diversity switching signal (CS1), thereby supplying the reception signal received by the antenna A2 to the mixer (MX1) 32 through the antenna switch (SW1) 31, and supplying the composite output signal from the mixer (MX1) 32 to the first antenna input terminal 11 of the radio module 10 through the antenna switch (SW2) 33 and signal cable 50 (step S16).

The level comparison circuit 15 compares again the signal level of the composite reception signal of the signals received by the antennas A1 and A2 which is input to the first antenna input terminal 11 with that of the reception signal received by the antenna B2 which is input to the second antenna input terminal 12 (step S2).

As described above, if the signal level of the reception signal received by the antenna B2 which is input to the second antenna input terminal 12 is higher than that of the composite reception signal of the signals received by the antennas A1 and A2 and that of the reception signal received by the antenna A2, the reception signal received by the antenna B2 is continuously selected (steps S2, S5, S6, S12, S15, S16, and S2 . . . ).

Assume that the level comparison circuit 15 compares the signal level of the composite reception signal of the signals received by the antennas A1 and A2 which is input to the first antenna input terminal 11 with that of the composite reception signal of the signals received by the antennas B1 and B2 which is input to the second antenna input terminal 12 (step S7), and determines that the signal level of the composite reception signal of the signals received by the antennas B1 and B2 which is input to the second antenna input terminal 12 is higher than that of the composite reception signal of the signals received by the antennas A1 and A2 which is input to the first antenna input terminal 11 (R_{A1+A2}<R_{B1+B2}). In this case, the diversity switch 17 selects the composite reception signal of the signals received by the antennas B1 and B2, which is input to the second antenna input terminal 12, in accordance with the diversity switching signal (CS1) output from the diversity switching signal generating circuit 16 (step S10).

In addition, the antenna switching control circuit 20 performs switching control of the antenna switches (SW1 and SW2) 31 and 33 provided in the antenna unit 30 by using the switching signal (CS2) on the basis of the diversity switching signal (CS1), thereby supplying the reception signal received by the antenna A2 to the first antenna input terminal 11 of the radio module 10 through the antenna switch (SW1) 31 and antenna switch (SW2) 33 (step S11).

In this state, the level comparison circuit 15 compares the signal level of the reception signal received by the antenna A2 which is input to the first antenna input terminal 11 with that of the composite reception signal of the signals received by the antennas B1 and B2 which is input to the second antenna input terminal 12, and determines which is higher in signal level (aperture stop S21).

If it is determined in this level comparison that the signal level of the composite reception signal of the signals received by the antennas B1 and B2 which is input to the second antenna input terminal 12 is higher than that of the reception signal received by the antenna A2 which is input to the first antenna input terminal 11 (R_{A2}<R_{B1+B2}), the diversity switch 17 selects the composite reception signal of the signals received by the antennas B1 and B2, which is input to the second antenna input terminal 12, in accordance with the diversity switching signal (CS1) from the diversity switching signal generating circuit 16 (step S24).

The antenna switching control circuit 20 performs switching control of the antenna switches (SW1 and SW2) 31 and 33 provided in the antenna unit 30 by using the switching signal (CS2) on the basis of the diversity switching signal (CS1), thereby supplying the reception signal received by the antenna A2 to the mixer (MX1) 32 through the antenna switch (SW1) 31, and supplies the composite output signal from the mixer (MX1) 32 to the first antenna input terminal 11 of the radio module 10 through the antenna switch (SW2) 33 and signal cable 50 (step S25).

The level comparison circuit 15 compares again the signal level of the composite reception signal of the signals received by the antennas A1 and A2 which is input to the first antenna input terminal 11 with that of the composite reception signal of the signals received by the antennas B1 and B2 which is input to the second antenna input terminal 12 (step S7).

As described above, if the signal level of the composite reception signal of the signals received by the antennas B1 and B2 which is input to the second antenna input terminal 12 is higher than that of the reception signal received by the antenna A2 and that of the composite reception signal of the signals received by the antennas A1 and A2, the composite reception signal of the signals received by the antennas B1 and B2 is continuously selected (steps S7, S10, S11, S21, S24, S25, S7 . . . ).

Assume that the level comparison circuit 15 compares the signal level of the reception signal received by the antenna A2 which is input to the first antenna input terminal 11 with that of the reception signal received by the antenna B2 which is input to the second antenna input terminal 12 (step S12), and determines that the signal level of the reception signal received by the antenna A2 which is input to the first antenna input terminal 11 is higher than (or equal to) that of the reception signal received by the antenna B2 which is input to the second antenna input terminal 12 (R_{A2}≧−R_{B2}). In this case, the diversity switch 17 selects the reception signal received by the antenna A2, which is input to the first antenna input terminal 11, in accordance with the diversity switching signal (CS1) output from the diversity switching signal generating circuit 16 (step S13).

In addition, the antenna switching control circuit 20 performs switching control of the antenna switches (SW3 and SW4) 41 and 43 provided in the antenna unit 40 by using the switching signal (CS2) on the basis of the diversity switching signal (CS1), thereby supplying the reception signal received by the antenna B2 to the mixer (MX2) 42 through the switch (SW3) 41, and supplying the composite output signal from the mixer (MX2) 42 to the second antenna input terminal 12 of the radio module 10 through the antenna switch (SW4) 43 and signal cable 60 (step S14).

In this state, the level comparison circuit 15 compares the signal level of the reception signal received by the antenna A2 which is input to the first antenna input terminal 11 with that of the composite reception signal of the signals received by the antennas B1 and B2 which is input to the second antenna input terminal 12, and determines which is higher in signal level (aperture stop S21).

If it is determined in this level comparison that the signal level of the reception signal received by the antenna A2 which is input to the first antenna input terminal 11 is higher than (or equal to) that of the composite reception signal of the signals received by the antennas B1 and B2 which is input to the second antenna input terminal 12 (R_{A2}≧−R_{B1+B2}), the diversity switch 17 selects the reception signal received by the antenna A2, which is input to the first antenna input terminal 11, in accordance with the diversity switching signal (CS1) from the diversity switching signal generating circuit 16 (step S22).

The antenna switching control circuit 20 performs switching control of the antenna switches (SW3 and SW4) 41 and 43 provided in the antenna unit 40 by using the switching signal (CS3) on the basis of the diversity switching signal (CS1), thereby supplying the reception signal received by the antenna B2 to the second antenna input terminal 12 of the radio module 10 through the switch (SW3) 41 and antenna switch (SW4) 43 (step S23).

The level comparison circuit 15 compares again the signal level of the reception signal received by the antenna A2 which is input to the first antenna input terminal 11 with that of the reception signal received by the antenna B2 which is input to the second antenna input terminal 12, and determines which is higher in signal level (step S12).

With such antenna switching control, the composite reception power of the two antennas or the reception power of one antenna is selected. This makes it possible to change the antenna arrangement in accordance with the state of interference, multipath, or fading.

The above antenna switching control can be easily realized by using the diversity switching signal (CS1) obtained by the radio module 10. A diversity antenna system with excellent reception characteristics can be realized by a simple circuit arrangement effectively using an existing radio module at a low cost, which can change the antenna arrangement in accordance with the state of interference, multipath, or fading.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information device comprising:
a pair of antenna units each including two antennas having different polarization characteristics or different directivities and a switching circuit which switches and outputs a composite reception signal of signals received by the two antennas or a reception signal received by one of the two antennas; and
antenna switching controller which performs switching control of the switching circuit of the pair of antenna units so as to form an antenna of a diversity scheme.

2. A device according to claim 1, wherein the antenna switching controller compares reception quality of a composite reception signal obtained by one of the pair of antenna units with reception quality of a reception signal received by one of the antennas of the other antenna unit, and performs switching control of the switching circuits of the pair of antenna units on the basis of the comparison result.

3. A device according to claim 2, wherein if it is determined upon comparison between the reception qualities that the reception quality of the composite reception signal obtained by the one antenna unit is higher, the antenna switching controller performs switching control of the switching circuit of the other antenna unit to output a composite reception signal of signals received by the two antennas from the switching circuit, compares the reception qualities of the composite reception signals from the pair of antenna units, and performs switching control of the switching circuits of the pair of antenna units on the basis of the comparison result.

4. A device according to claim 2, wherein if it is determined as a result of comparison between the reception qualities that the reception quality of the reception signal received by one antenna of the other antenna unit is higher, the antenna switching controller performs switching control of the switching circuit of the one antenna unit to output the reception signal received by the one antenna from the switching circuit, compares the reception quality of the reception signal received by one of the antennas of one of the pair of antenna units with the reception quality of the reception signal received by one of the antennas of the other of the pair of antenna units, and performs switching control of the switching circuits of the pair of antenna units on the basis of the comparison result.

5. A device according to claim 1, wherein the antenna switching controller receives a diversity switching signal from a radio module having a function of outputting a diversity switching signal, and performs switching control of the switching circuits of the pair of antenna units.

6. A device according to claim 1, wherein the antenna unit comprises a mixer which receives and mixes reception signals received by the two antennas having different polarization characteristics or different directivities, and interlocking switches for two circuits which are switched/controlled by the antenna switching controller, and outputs a composite reception signal of signals received by the two antennas or a reception signal received by one of the two antennas upon switching control of the interlocking switches.

7. A device according to claim 6, wherein each of the pair of antenna units is formed into a module, and the pair of antenna units formed into the modules and the antennas of each of the pair of antenna units are arranged to be spaced apart from each other by a predetermined distance.

8. A control method for a diversity antenna comprising a pair of antenna units each including two antennas having different polarization characteristics or different directivities and a switching circuit which switches and outputs a composite reception signal of signals received by the two antennas or a reception signal received by one of the two antennas,
wherein an antenna of a diversity scheme is formed from the antennas of the pair of antenna units by performing switching control of the switching circuits of the pair of antenna units on the basis of the reception signals received by the pair of antenna units.

9. A method according to claim 8, wherein the switching control includes comparing reception quality of a composite reception signal obtained by one of the pair of antenna units with reception quality of a reception signal received by one of the antennas of the other antenna unit, and performing switching control of the switching circuits of the pair of antenna units on the basis of the comparison result.

10. A method according to claim 9, wherein the switching control includes, if it is determined upon comparison between the reception qualities that the reception quality of the composite reception signal obtained by the one antenna unit is higher, performing switching control of the switching circuit of the other antenna unit to output a composite reception signal of signals received by the two antennas from the switching circuit, comparing the reception qualities of the composite reception signals from the pair of antenna units, and performing switching control of the switching circuits of the pair of antenna units on the basis of the comparison result.

11. A method according to claim 9, wherein the switching control includes, if it is determined as a result of comparison between the reception qualities that the reception quality of the reception signal received by one antenna of the other antenna unit is higher, performing switching control of the switching circuit of the one antenna unit to output the reception signal received by the one antenna from the switching circuit, comparing the reception quality of the reception signal received by one of the antennas of one of the pair of antenna units with the reception quality of the reception signal received by one of the antennas of the other of the pair of antenna units, and performing switching control of the switching circuits of the pair of antenna units on the basis of the comparison result.
